(19) United States
(12) Patent Application Publication
(10) Pub. No.: US 2013/0142479 A1
(43) Pub. Date: Jun. 6, 2013

(54) CHIP PACKAGE

(71) Applicants: KAI-WEN WU, Tu-Cheng (TW); TAI-CHERNG YU, Tu-Cheng (TW)

(72) Inventors: KAI-WEN WU, Tu-Cheng (TW); TAI-CHERNG YU, Tu-Cheng (TW)

(73) Assignee: HON HAI PRECISION INDUSTRY CO., LTD., Tu-Cheng (TW)

(21) Appl. No.: 13/598,810

(22) Filed: Aug. 30, 2012

(30) Foreign Application Priority Data
Dec. 5, 2011 (TW) 100144734

(51) Int. Cl. G02B 6/12

(52) U.S. Cl. 385/14

(57) ABSTRACT

A chip package includes a substrate, an electrical module, an optical module and a transmission module. The electrical module and the optical module are positioned on the substrate and electrically connect with each other. The optical module is used for converting optical signals to electrical signals, and vice versa. The optical module includes an optical emitting element and optical receiving element. The transmission module is positioned on the substrate. The transmission module includes an optical wave guide array having a reflection surface and a plurality of optical fibers that are optically coupled with the optical wave guide array. The optical signals emitted by the optical module are reflected by the reflection surface and reach the optical fibers to be transmitted; the optical module is capable of receiving optical signals from the optical fibers.

### BACKGROUND

1. Technical Field

The present disclosure relates to package structures, and particularly, to a chip package.

2. Description of Related Art

In optical communication, optical emitting elements are used to convert electrical signals to optical signals, and optical receiving elements are used to convert optical signals to electrical signals. The chip on board (COB) method is one technique to package the optical elements. Lenses need to be optically coupled with the optical elements during the package process. After performing the die bonding of the optical elements, the lenses need to cover the optical elements precisely. However, the positions of the lenses are easily mis-aligned to become inclined. Thus, it is difficult to optically couple the lenses and the optical elements precisely. In addition, the number of the optical elements will be increased with the demand of the higher data transmission. It is no doubt that the difficulty of arrangement of the optical elements and the lenses will be increased during the COB process.

Therefore, there is room for improvement within the art.

### BRIEF DESCRIPTION OF THE DRAWINGS

The components in the drawings are not necessarily drawn to scale, the emphasis being placed upon clearly illustrating the principles of the present disclosure. Moreover, in the drawings, like reference numerals designate corresponding parts throughout several views, and all the views are schematic.

FIG. 1 is a cross-section of an embodiment of a chip package.

FIG. 2 is a cross-section of the embodiment of a chip package from another aspect.

### DETAILED DESCRIPTION

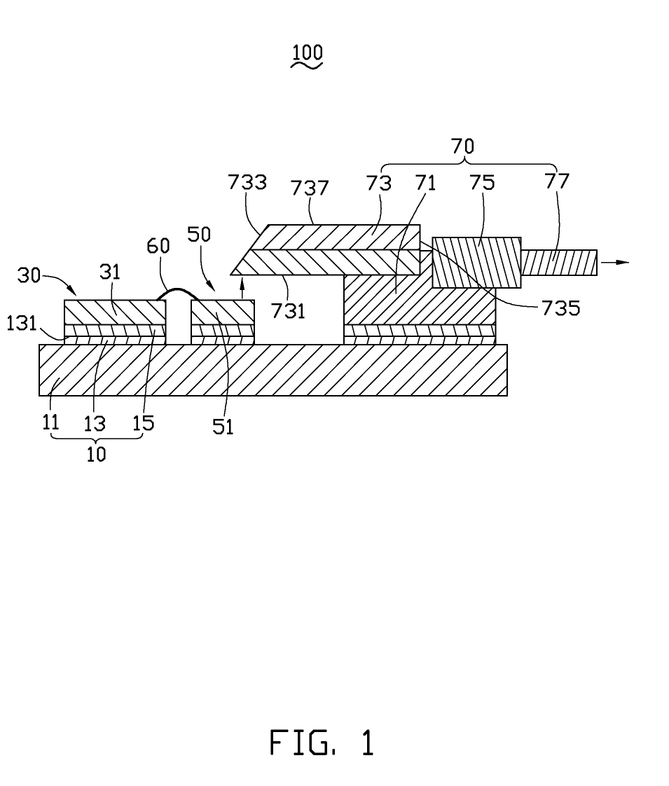

FIG. 1 shows an embodiment of a chip package 100 used for converting and transmitting electrical and optical signals. The chip package 100 includes a substrate 10, an electrical module 30, an optical module 50, and a transmission module 70. The electrical module 30, the optical module 50 and the transmission module 70 are positioned on the substrate 10 in order, and are spaced from each other. The electrical module 30 and the optical module 50 are electrically connected with each other.

The substrate 10 supports the electrical module 30, the optical module 50, and the transmission module 70. The substrate 10 includes a base board 11, a plurality of pads 13, and a plurality of fixing layers 15. A plurality of circuits (not shown) is arranged on the base board 11 to drive the electrical module 30, the optical module 50 or other functional units to work. The pads 13 are soldered on the base board 11, on which the electrical module 30, the optical module 50 and the transmission module 70 are packaged thereon. The pads 13 are made of one or more electrical conductive metal materials, such as cooper, nickel, sliver, or other alloys. Each pad 13 has a surface 131 deviating from the substrate 10. The fixing layers 15 are respectively formed on the surfaces 131 via a eutectic bond process. In the illustrated embodiment, the fixing layer 15 is made of a thin tin layer, coated on the surfaces 131 and heated by laser after the electrical module 30 and the optical module 50 are positioned on the thin metal layer. In other embodiments, the fixing layer 15 may be an adhesive layer.

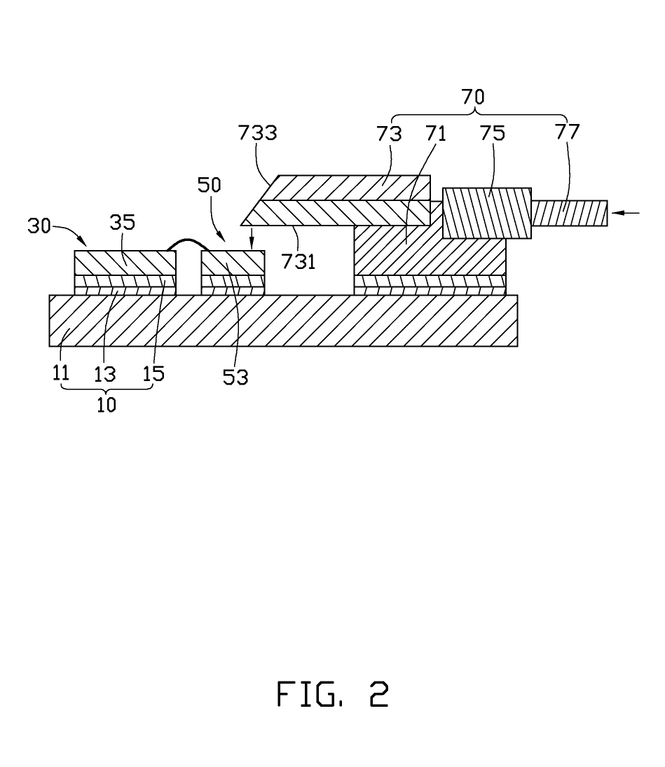

Referring also to FIG. 2, the electrical module 30 is positioned on one fixing layer 15 at one end of the substrate 10 for receiving the electrical signals. In the illustrated embodiment, the electrical module 30 includes a first electrical element 31 (as shown in FIG. 1) and a second electrical element 35 (as shown in FIG. 2). The first electrical element 31 and the second electrical element 35 are positioned on the fixing layer 15 side by side. The first electrical element 31 is an integrated circuit board. The second electrical element 35 is a trans-impedance amplifier.

The optical module 50 is positioned on one fixing layer 15 in a middle portion of the substrate 10, and is located adjacent to the electrical module 30. The optical module 50 includes an optical emitting element 51 (as shown in FIG. 1) and an optical receiving element 53 (as shown in FIG. 2). In the illustrated embodiment, the optical emitting element 51 and the optical receiving element 53 are positioned side by side. The optical emitting element 51 is used for converting the electrical signal from the first electrical element 31 to the optical signals. The optical signals emitted by the optical emitting element 51 are configured in vertical direction with respect to the base board 13. In the illustrated embodiment, the optical emitting element 51 is a vertical cavity surface emitting laser; the optical receiving element 53 is a photo diode. A wire 60 is produced by the wire bond performing to electrically connect with the optical emitting element 51 and the first electrical element 31. The optical receiving element 53 is also electrically connected with the second electrical element 35 by a wire 60.

The transmission module 70 is positioned on one of the fixing layers 15 at another end of the substrate 10 opposite to the electrical module 30 for transmitting the optical signals. The optical module 50 is located between the electrical module 30 and the transmission module 70. The transmission module 70 includes a fixing array 71, an optical wave guide array 73, an optical connector 75, and a plurality of optical fibers 77. The fixing array 71 is positioned on one of the fixing layer 15 at another end of the substrate 10 opposite to the electrical module 30. The optical wave guide array 73 is mounted on the fixing array 71, and is parallel to the base board 11 for transmitting the optical signals. The optical connector 75 is positioned on the fixing array 71 at a side of the optical wave guide array 73. The optical fibers 77 are optically coupled with another end of the optical connector 75.

The optical wave guide array 73 includes a bottom surface 731, a reflection surface 733, a transmission surface 735, and a top surface 737. The bottom surface 731 is positioned on the fixing array 71. Optical signals enter or exit the optical wave guide array 73 via the bottom surface 731 thereof. The reflection surface 733 and the transmission surface 735 extend from the opposite ends of the bottom surface 731 to connect with the top surface 737. The reflection surface 733 is used for changing the transmission direction of the optical signals. Optical signals enter or exit the optical wave guide array 73 via the transmission surface 735 thereof. In the illustrated embodiment, an inclined angle defined by the bottom surface 731 and the reflection surface 733 is about 45 degrees, and the transmission surface 735 is substantially perpendicular to the bottom surface 731. The top surface 737 is parallel to the bottom surface 731. The optical wave guide array 73 is mounted on the fixing array 71 at one end of the optical wave guide array 73 which has the transmission surface 735. Another end of the optical wave guide array 73 which has the reflection surface 733 extends above of the optical module 50. The optical connector 75 is positioned on the fixing array 71, and is optically coupled with the transmission surface 735 at one end of the optical connector 75. The optical fibers 77 are optically coupled with another end of the optical connector 75.

When the first electrical element 31 sends the electrical signals to the optical emitting element 51, the optical emitting element 51 converts the electrical signals to optical signals. The optical emitting element 51 emits the optical signals toward the optical wave guide array 73 vertically to the substrate 10. The optical signals vertically enter the bottom surface 731, are then reflected by the reflection surface 733 to change the transmitting direction thereof, and reach the transmission surface 735. The optical signals enter the optical connector 75 and finally arrive at the optical fiber 77 for long distance transmission.

When the optical fiber 77 receives the optical signals, the optical signals reach the optical wave guide array 71 via the transmission through the optical connector 75. The optical receiving element 53 receives and converts the optical signals to the electrical signals. Then the electrical signals are transmitted to the second electrical element 35 by the optical receiving element 53.

The chip package 100 is capable of transmitting data information in two directions for long distance. The reflection surface 733 of the optical wave guide array 73 is located above the optical module 50. The optical signals are reflected by the reflection surface 733 to change the transmission direction thereof. There is no lens in the chip package 100 and the structure of the chip package 100 is simpler. Therefore, even if the number of the optical emitting element 51 and the optical receiving element 53 are increased, the accuracy of the alignment of the optical emitting element 51, the optical receiving element 53 and the optical wave guide array 71 are easy to achieve.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A chip package, comprising:
a substrate;
an electrical module positioned on the substrate;
an optical module positioned on the substrate and electrically connected with the electrical module for converting the optical signals and electrical signals; and
a transmission module positioned on the substrate comprising:
an optical wave guide array comprising a reflection surface located above the optical module;
a plurality of optical fibers optically coupled with the optical wave guide array, wherein the optical signals emitted by the optical module are reflected by the reflection surface and reach the optical fibers to transmit, and the optical module is capable of receiving the optical signals from the optical fibers.

2. The chip package of claim 1, wherein the transmission module further comprises a fixing array, the fixing array is positioned on the substrate, the optical wave guide array is positioned on the fixing array and parallel to the substrate.

3. The chip package of claim 1, wherein the optical wave guide array further comprises a bottom surface and a transmission surface, the reflection surface and the transmission surface extend from the opposite ends of the bottom surface.

4. The chip package of claim 3, wherein the inclined angle defined by the bottom surface and the reflection surface is 45 degrees.

5. The chip package of claim 4, wherein the transmission surface is perpendicular to the bottom surface.

6. The chip package of claim 2, wherein the transmission module further comprises an optical connector, the optical connector is positioned on the fixing array, and the plurality of optical fibers is optically coupled with the optical wave guide array via the optical connector.

7. The chip package of claim 1, wherein the optical module is electrically connected with the electrical module via one or more wire.

8. The chip package of claim 1, wherein the electrical module comprises a first electrical element and a second electrical element, the first electrical element and the second electrical element are positioned on the substrate side by side, the first electrical element sends the electrical signals to the optical module, the second electrical element receives the electrical signals from the optical module.

9. The chip package of claim 1, wherein the substrate comprises a base board, a plurality of pads and a plurality of fixing layers, the plurality of pads are soldered on the base board; the plurality of fixing layers are formed respectively on the plurality of pads, the electrical module, the optical module, and the transmission module are positioned on the plurality of fixing layers.

10. The chip package of claim 1, wherein the optical module comprises an optical emitting element and an optical receiving element, the optical emitting element and an optical receiving element are positioned on the substrate side by side, the optical emitting element converts the electrical signals to the optical signals and emits the optical signals to the reflection surface, the optical receiving element receive the optical signals from the reflection surface and converts the optical signals to the electrical signals.
